(19) United States
(12) Patent Application Publication
(10) Pub. No.: US 2005/0097291 A1
(43) Pub. Date: May 5, 2005

(54) Multiple data rate bus using return clock

(75) Inventor: Jonghee Han, Cary, NC (US)

Correspondence Address: GERO G. McCLELLAN;MOSER, PATTERSON & SHERIDAN, L.L.P., Suite 1500, 3040 Post Oak Blvd., Houston, TX, 77056, US

(73) Assignee: INFINEON TECHNOLOGIES NORTH AMERICA CORP.

(21) Appl. No.: 10/699,473

(22) Filed: Oct. 31, 2003

(51) Int. Cl. G06F 12/00

(52) U.S. Cl. 711/167; 711/105

(57) ABSTRACT

A method and apparatus for ensuring safe transmission of data on a bus line. In one embodiment, within a given clock period, first data is driven on a data bus and a strobe signal is transmitted, via a first signal path, to a receiving circuit indicating the validity of the first data on the data bus. A return signal received within the given clock period indicates an assumed arrival of the strobe signal at the receiving circuit. In response to receiving the return signal, second data is driven onto the data bus.

### BACKGROUND OF THE INVENTION

1. Field of the Invention

The present invention generally relates to integrated circuit memory devices and, more particularly, to synchronous dynamic random access memory (SDRAM) devices.

2. Description of the Related Art

An increasing number of electronic equipment and electronic-based systems require high-speed memory devices for storing and retrieving information (or “data”). Synchronous dynamic random access memory (SDRAM) devices is one of the most commonly used types of such memory devices. In a SDRAM device, specific functions must occur in a predetermined sequence. Such functions are generally performed in response to command signals produced by a system controller of the SDRAM device. The timing of the command signals is determined by a clock signal (CLK) and is registered either to an edge of the clock signal or a predetermined time after the edge.

As operating frequencies of memory devices continue to increase, the required bandwidth of the internal and external data buses used by these devices must increase, accordingly. One approach to increase internal bus bandwidth is to increase the number of lines of the bus. While this approach is simple, it comes at the expense of device area and power. Another approach is to increase the data rate per line. For example, in a double data rate (DDR) SDRAM, data rates have been increased from one bit per clock cycle to two bits per clock cycle.

When increasing bit rates per clock cycle per line, a number of design problems with respect to the internal buses are presented. For example, one problem when driving data on an internal bus is notifying receiving circuitry when the data can be latched in. This notification is typically provided by a strobing (clock) signal. The strobing signal is driven at the same location as the other data and runs through to the receiver circuitry along the same path as the data, in an effort to ensure the data and strobing signals arrive at the receiver circuitry with a substantially similar propagation delay. Therefore, the arrival of the edge of strobing signal at the receiver circuitry, indicates to the receiver circuitry that the data on the bus can be safely latched in.

In a conventional DDR memory, the driver circuitry starts to send the second data a short time after the first data is sent. A problem with DDR memory is determining how long driving circuitry should drive first data on the bus prior to driving the second data. That is, while the strobing signal (which travels only one way, from the driving circuitry to the receiver circuitry) effectively notifies the receiver circuitry of the presence of first data on the bus, the driver circuitry receives no indication of when the receiver circuitry has successfully latched-in the data. Accordingly, the first data should be driven long enough to ensure the data is latched in safely by the receiving circuitry, but short enough to ensure adequate time to send the second data within the single clock cycle. Conventional driver circuitry relies on a somewhat arbitrary delay and assumes the data has been latched in by the receiver after the expiration of the delay. This delay is inevitably less than optimal in some cases. If the delay is too long, achievable data rate may be sacrificed. If the delay is too short, the second data may be driven before the first data is latched in, possibly resulting in lost data.

Accordingly, what is needed is a apparatus and method for notifying a multi-bit per cycle driving circuit, that a first bit of data has been latched in by a receiving circuit and that a second bit of data may be safely sent.

### SUMMARY OF THE INVENTION

The present invention generally provides methods and apparatus for ensuring safe transmission of data on a bus line.

In one embodiment, within a given clock period, first data is driven on a data bus and a strobe signal is transmitted, via a first signal path, to a receiving circuit indicating the validity of the first data on the data bus. A return signal received within the given clock period indicates an assumed arrival of the strobe signal at the receiving circuit. In response to receiving the return signal, second data is driven onto the data bus.

Another embodiment provides a method of operating a multiple date rate memory device, comprising, within a given clock period (a) driving a first data on a data bus; (b) issuing a strobe signal from a controller; (c) receiving, by a receiving circuit, the strobe signal a period of time after issuing the strobe signal; (d) in response to receiving the strobe signal by the receiving circuit, latching in the first data from the data bus; (e) receiving, by the controller, the strobe signal a period of time after issuing the strobe signal; and (f) in response to receiving the strobe signal by the controller, driving a second data on a data bus.

Another embodiment provides a method of operating a multiple date rate memory device, comprising, within a given clock period: (1) by a driver controller: driving first data on a data bus; transmitting a data strobe signal to a receiver via a forward signal path; receiving the data strobe signal via a return signal path; and in response to receiving the strobe signal, driving second data on the data bus; and (2) by a receiver: receiving the strobe signal via the forward signal path; and in response to receiving the strobe signal, latching the first data in from the data bus.

Yet another embodiment for operating a multiple date rate memory device within a given clock period comprises enabling a driver to drive a first data on a data bus; issuing a strobe signal to a receiving circuit via a forward signal path to indicate the presence of the first data on the data bus; receiving the strobe signal via a return signal path, wherein receipt of the strobe signal indicates an assumed arrival of the strobe signal at the receiving circuit via the forward signal path; and in response to receiving the strobe signal, enabling a driver to drive a second data on the data bus.

Another embodiment provides a multiple data rate memory device. The device comprises a controller configured to generate one or more driver-enable signals and a strobe clock signal; a data bus; a driver circuit configured to drive at a first data and a second data on the data bus in response to the one or more driver-enable signals from the controller; a receiver circuit configured to receive the first and second data via the data bus, the receiver circuit configured to latch the first and second data in response to a strobing clock signal generated by the controller; a strobe clock signal line to propagate the strobing clock signal from the controller to the receiver circuit; and a round-trip path comprising a return path for the strobing clock signal back to the controller. The controller is configured to enable the driver circuit to drive the first data on the data bus, generate the strobing clock signal to the receiver circuit on the strobe clock signal line, receive the strobing clock signal on the round-trip path and, in response to receiving the strobe clock signal, enable the driver circuit to drive the second data on the data bus.

Another embodiment of a multiple data rate memory device comprises a driver configured to drive at least a first data and a second data; a receiver coupled to the driver; a controller coupled to the driver and configured to enable the driver to drive the first data and the second data; a strobe clock signal line coupled between the receiver and controller and configured to propagate a strobe clock signal; and a return clock signal line coupled at an output end to the controller and configured to propagate a return clock signal signaling the controller to enable the driver to drive the second; wherein the return clock signal is timed off of the strobe clock signal.

Another embodiment provides a clocking circuit in a multiple data rate memory device. The clocking circuit comprises a controller comprising a strobe clock signal output and a return clock signal input and configured to issue a first enable signal and a second enable signal, the first enable signal enabling a plurality of drivers to drive respective first data on respective data lines, and the second enable signal enabling the plurality of drivers to drive respective second data on their respective data lines; a strobe clock signal line coupled to the strobe clock signal output; and a return clock signal line coupled to the return clock signal input, wherein the strobe clock signal line defines an initial portion of a round-trip path and the return clock signal line defines a terminal portion of the round-trip path. The controller is configured to: respond to an external clock signal by pulling a strobe clock signal to a first state on the strobe clock signal line and pulling the first enable signal to an active state; receive a return clock signal on the return clock signal line a period of time after pulling the strobe clock signal to the first state, wherein the return clock signal is timed off of the strobe clock signal and indicates an assumed receipt of the strobe clock signal in the active state by receiving circuitry coupled to the respective data lines and configured to latch in the first and second data from the data lines in response to the strobe clock signal; and respond to the received return clock signal by pulling the second enable signal to an active state.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic of one embodiment of a memory device having a return clock circuit.

FIG. 2 is a schematic of one embodiment of a data bus and associated strobe/return clock signal circuitry.

FIG. 3 is one embodiment of a timing diagram illustrating a return clock signal.

FIG. 4 is another embodiment of a timing diagram illustrating a return clock signal.

FIG. 5 is another embodiment of strobe/return clock signal circuitry.

FIG. 6 is another embodiment of strobe/return clock signal circuitry.

FIG. 7 is an embodiment of strobe/return clock signal circuitry in which a return clock circuit is implemented for a bidirectional bus.

FIG. 8 is another embodiment of strobe/return clock signal circuitry in which a return clock circuit is implemented for a bidirectional bus.

### DETAILED DESCRIPTION OF THE PREFERRED EMBODIMENTS

The present invention provides methods and apparatus for ensuring safe transmission of data on a bus line using a return clock.

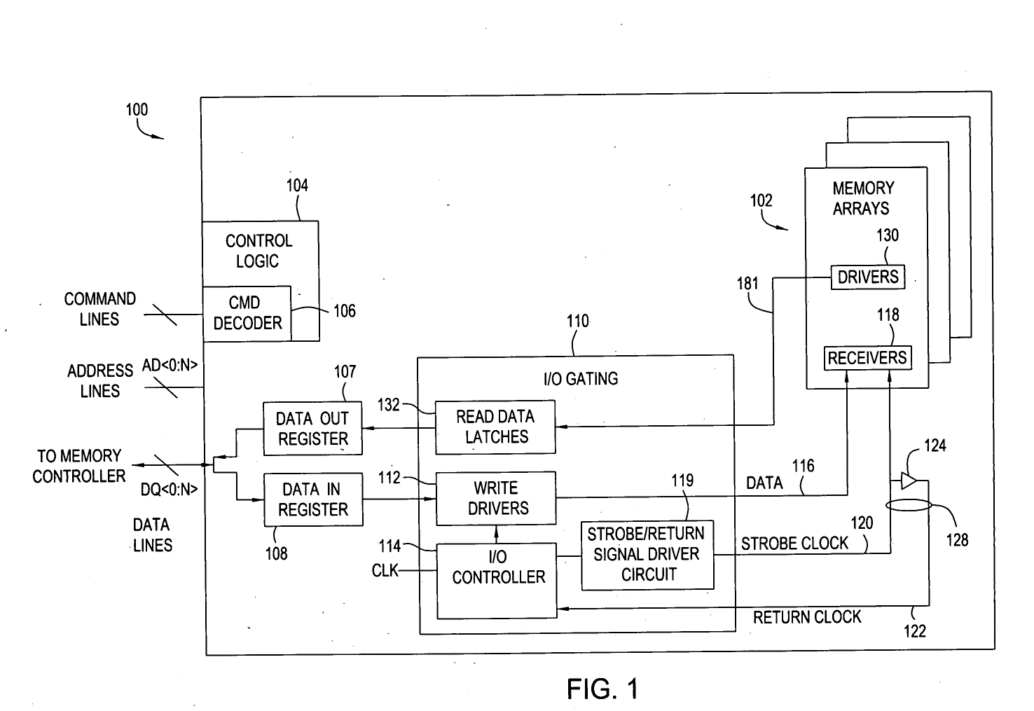

FIG. 1 illustrates an exemplary DDR DRAM device 100 utilizing a “return clock” signal in accordance with embodiments of the present invention. The DDR DRAM device 100 generally includes a plurality of memory arrays 102 and various control logic 104, such as a command decoder 106, used to interpret externally supplied commands to access (e.g., read, write, or refresh) data stored in the memory arrays 102. As illustrated, data to be read from the memory arrays 102 may be driven by drivers 130 to a read data latch 132, via an internal bus 131, and then placed onto an external data bus (labeled DQ[0:N]) from a data out register 107. Similarly, data to be stored in the memory arrays 102 may be latched from the external data bus into a data-in register 108. From the data-in register 108, the data may be written to the memory arrays 102 by driving the data onto an internal data bus 116, via write driver circuits 112 of an I/O gating 110. The internal data bus 116 is coupled to receivers 118 which latches the incoming data. The internal data bus 116 may also be referred to as an “on-chip” bus since this bus is an element of the DDR DRAM device 100 which couples other elements resident on the DDR DRAM device 100. This may be contrasted to the external data bus, DQ[0:N], which couples the DDR DRAM device 100 to some other external device, e.g., a controller.

In double data rate operation, first and second data is sent on rising and falling edges of a same clock signal. This may be accomplished via an I/O controller 114 generally configured to enable different write drivers of the driver circuits 112 to drive the first and second data during a single period of a bus clock signal (CLK).

A strobe clock signal (also referred to as strobe signal), driven from the same location as the data may be provided to notify the receivers 118 the data on the bus 116 is ready to be latched in. Illustratively, a strobe/return signal driver circuit 119 is provided for this purpose. The strobe/return signal driver circuit 119 issues a strobe clock signal on a stroke clock line 120. Recall that, in conventional DDR SDRAM devices, one problem presented is how long the individual write drivers of the driver circuits 112 should drive the first data on the bus 116 prior to driving the second data. Embodiments of the present invention may overcome this problem, however, by utilizing a return clock signal as an indication that the driver circuits 112 may drive the second data on the bus 116, as described herein.

As illustrated, the return clock signal may be carried on a conductive line 122 (also referred to herein as the “return clock line 122”). In one aspect, the line 122 provides a return path from some point along the conductive line 120 used to provide the strobe clock signal from the strobe/return signal driver circuit 119 to the receiver 118. In other words, the return clock signal is a “copy” of the strobe clock signal (or is the strobe clock signal itself) returned to an I/O controller 114 that controls the driver circuits 112, the timing of which is based on the return clock line 122.

Thus, (at least in one embodiment) a portion of the conductive line 120, and the entirety of the conductive line 122, form a round-trip path 128 used to signal the I/O controller 114 that (for a single period of the CLK signal) the first data has been latched at the receivers 118 and the second data may be driven from the driver circuits 112. The portion of the conductive line 120 contributing to the round-trip path is shown as a double line. However, this pictorial representation is merely for purposes of illustration, and it is understood that, at least in one embodiment, the conductive lines 120 and 122 may be bidirectional lines shared between different driving controllers on opposite ends of the lines. In any case, the strobe clock signal return to the controller 114 via the line 122 is also referred to herein as the return clock signal, or simply return signal.

Depending upon the implementation, the round-trip path 128 may have one or more in-line buffers. Illustratively, one buffer 124 is shown at a turn-around point in the round-trip path 128. In other implementations, the buffer 124 may not be needed. Whether a buffer is needed may be dependent on the particular construction of the round-trip path 128 and the resulting signal attenuation.

Generally, the round-trip path 128 provides for a delay sufficient to allow receivers 118 to receive and latch in the first data prior to the driver circuits 112 driving the second data. Optimally, the delay is no longer than is necessary to ensure the first data has been latched at the receivers 118 so the clock frequency may be increased, thereby achieving greater overall speeds. In a particular embodiment, the round-trip path 128 is designed to provide for a delay at least equal to the propagation time of the strobing clock signal from the strobe/return signal driver circuit 119 to the receivers 118 via the line 120. Therefore, the round trip path 128 will generally be at least as long as the strobe clock line 120. As will be described in greater detail below, this may generally be accomplished by originating the return clock line 122 from a point on the strobe clock line 120 at least half way between the strobe/return signal driver circuit 119 and the receivers 118. The delay may also account for any processing time required by various components processing the strobing clock signal.

In any case, the provision of a round-trip path as described herein is used to signal an assumed successful arrival of data at an intended destination (e.g. at the receivers 118). To this end, the round-trip path 128 is preferably constructed to replicate the path of the internal data bus 116. Thus, the materials used for construction of the internal data bus 116 may be the same as those used for the strobing clock signal line 120 and the return clock signal line 122. As a result, the round-trip path 128 and the bus 116 are normalized with respect to processing conditions, such as temperature, that may affect signal propagation times.

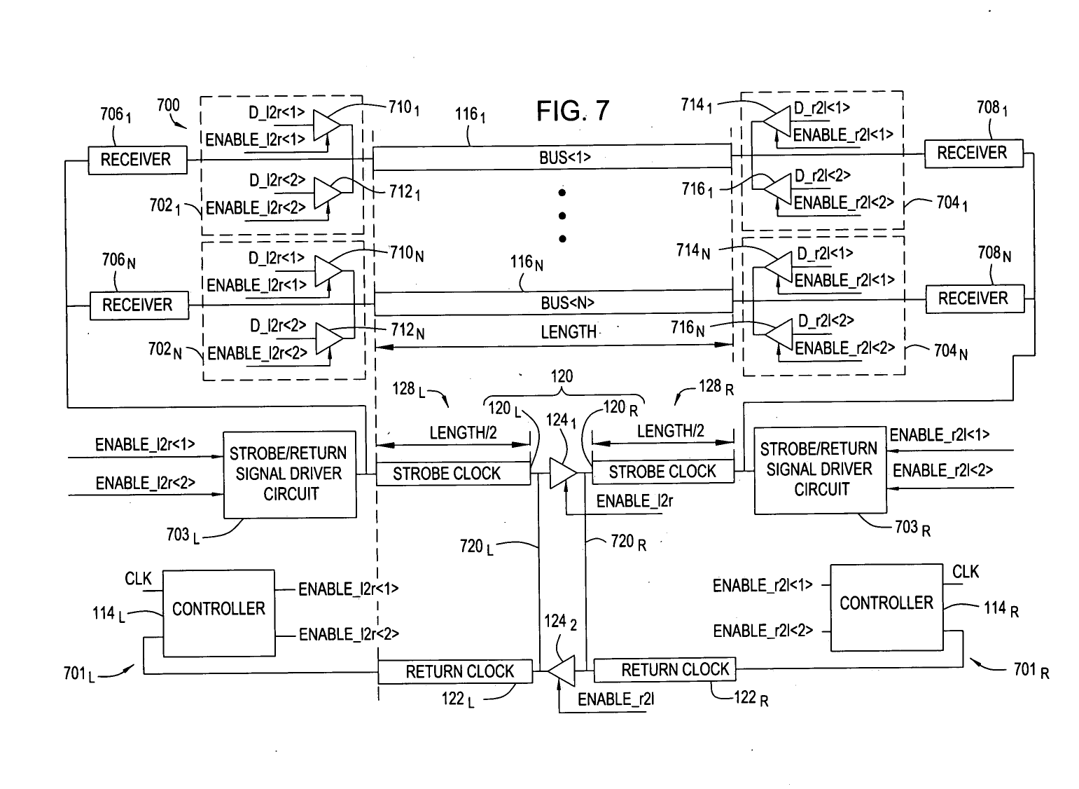

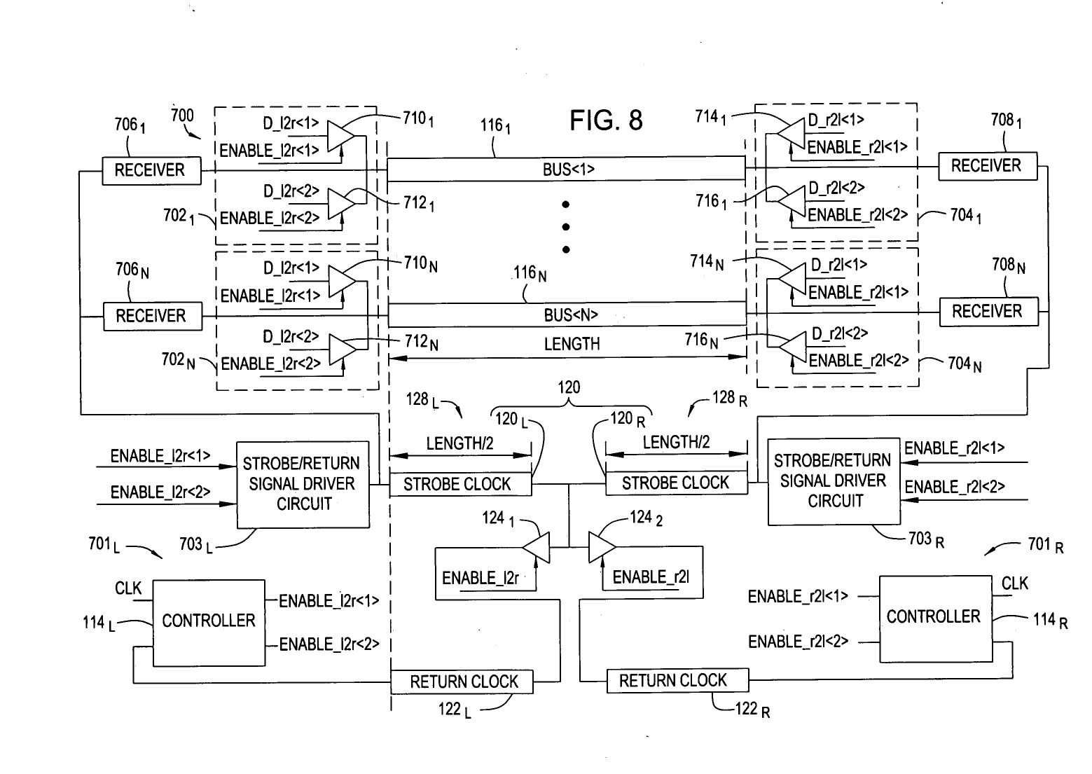

Of course, a return clock signal and similar circuitry may also be utilized when reading data from the memory arrays 102 at a double data rate. In other words, a round-trip path (for propagating strobe clock signals and corresponding return clock signals) may also be used when transferring data between drivers 130 of the memory arrays 102 and read data latches 132. In some cases, a return clock may be provided for both reading and writing and strobing and return signals may share one or more common bi-directional lines. An illustrative embodiment to this end is shown in FIGS. 7-8, and is described below.

Further, it is understood that FIG. 1 is merely illustrative. Persons skilled in the art will recognize that aspects of the invention may be implemented differently. In addition, the memory device 100 of FIG. 1 has been simplified in some respects relative to current memory devices. Accordingly, in practice, a memory device may have a variety of other circuits not shown in FIG. 1. Accordingly, whether a particular circuit has more, less or different circuitry than that shown in FIG. 1 is not limiting of the invention.

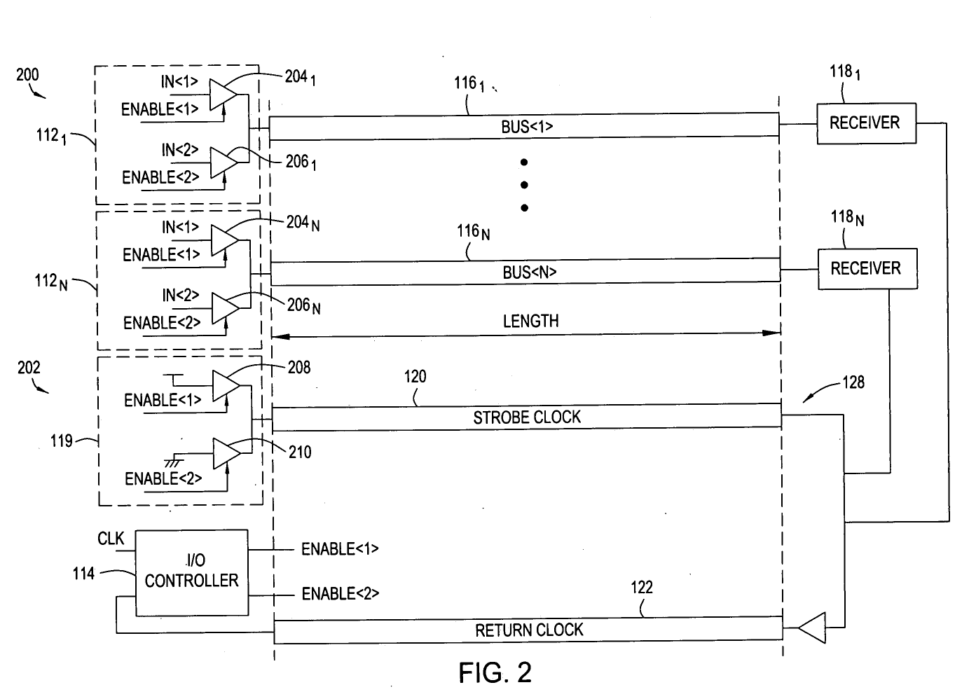

A variety of embodiments of the round-trip path 128, related circuitry and operation of the same are now described with reference FIGS. 2-8. Wherever possible, like numerals are used to identify components described with reference to FIG. 1. Otherwise, similar components may be identified by like terminology (as in the case of FIGS. 7 and 8). However, it is understood that such identification of components is done merely for convenience and the embodiments of FIGS. 2-8 are not limited to the device shown in FIG. 1. Further, each instance of device circuitry shown and described in FIGS. 2-8 illustrates a double data rate implementation. It is understood, however, that embodiments of the invention include any multiple rate memory devices and related circuits. That is the return clock of the present invention may be any memory device configured to drive two or more data during a given clock cycle.

Referring first to FIG. 2, an embodiment of data circuitry 200 and control/clocking circuitry 202 is shown. The data circuitry 200 comprises a plurality of data bus lines 116₁, 116₂, . . . 116_{N}. The bus lines 116₁, 116₂, . . . 116_{N} may be representative of the individual lines of the bus 116 shown in FIG. 1 and are therefore collectively referred to as the bus 116, or the bus lines 116. The bus lines 116 are coupled at one end to respective driver circuits 112₁, 112₂, . . . 112_{N} (collectively representative of the “driver circuits 112” of FIG. 1) and at another end to respective receivers 118₁, 118₂, . . . 118_{N} (collectively representative of the “receivers 118” of FIG. 1). The driver circuits 112 are each configured to drive multiple (at least two) data each clock cycle. Illustratively, the driver circuits 112 are implemented for a double data rate memory device and, accordingly, the driver circuits 112 each have first data inputs, In<1>, to respective first drivers 204₁, 204₂ . . . 204_{N} (collectively, drivers 204) and second data inputs, In<2>, to respective second drivers 206₁, 206₂ . . . 206_{N} (collectively, drivers 206).

The drivers 204, 206 are enabled to drive their respective data by the I/O controller 114 which is configured to issue two enable signals, Enable<1> and Enable<2>. The controller 114 asserts (e.g., drives high) a first enable signal, Enable<1>, to enable the first drivers 204 to drive their respective first data, In<1>, on their respective bus lines 116 and pulls a second enable signal, Enable<2>, to an active state to enable the second drivers 206 to drive their respective second data, In<2>, on their respective bus lines 116.

The strobe/return signal driver circuit 119 of the control/clocking circuitry 202 is also configured with a pair of drivers responsive to the first and second enable signals. In particular, the strobe/return signal driver circuit 119 includes a first driver 208 that is enabled in response to the first enable signal, Enable<1>, and a second driver 210 that is enabled in response to the second enable signal, Enable<2>. In one embodiment, asserting the first enable signal causes the first driver 208 of the strobe/return signal driver circuit 219 to drive a strobe signal HIGH on the conductive line 120 of the round-trip path 128. Asserting the second enable signal causes the second driver 210 of the strobe signal driver circuit 119 to drive the strobe signal LOW.

Illustratively, the turnaround point for the round-trip path 128 is approximately at a midpoint of the round-trip path 128. Accordingly, the strobe clock signal line 120 and the return clock signal line 122 are of approximately equal lengths. Further, the strobe clock signal line 120 and the return clock signal line 122 are of approximately equal lengths with respect to the bus lines 116. Thus, a strobe signal issued by the strobe/return signal driver circuit 119 has a propagation time substantially equal to the propagation time of a data signal from any and each of the driver circuits 112. Receipt of the strobe signal at the terminal end of the line 120, signals the receivers 118 to latch in the data on the bus lines 116. In this particular implementation, the strobe signal is also buffered at the midpoint of the round-trip path 128 by the buffer 124, which then issues a return signal to the I/O controller 114 via the return clock signal line 122. Receipt of the return signal causes the I/O controller 114 to enable the second drivers 206 to drive second data onto the bus lines 116.

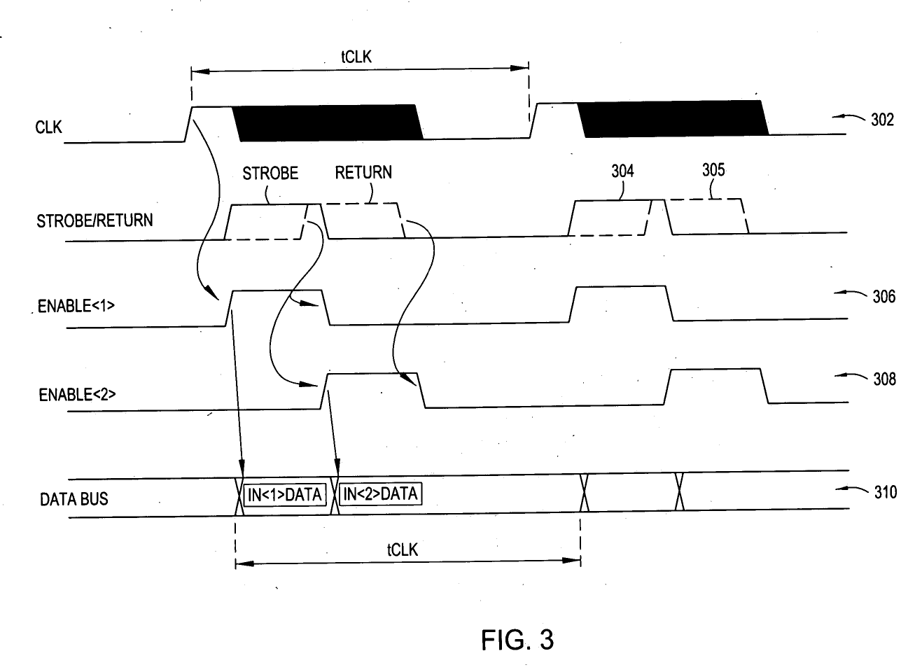

The operation of the data circuitry 200 and the control/clocking circuitry 202 of FIG. 2 may be further illustrated with reference to the timing diagram of FIG. 3. In general, the timing diagram illustrates the driver control for a double data rate memory device, in which first and second data are driven onto a bus within a given period, tCLK, of a clock signal (CLK) 302 input to the I/O controller 114. The rising edge of the clock signal 302 causes the controller 114 to assert the first enable signal 306, Enable<1>. As a result, each of the first drivers 204 of the driver circuits 112 is enabled to drive first data, In<1>, onto their respective bus lines 116 as indicated by the first solid straight arrow relating the first enable signal 306 to the data 310 on the bus lines.

Asserting the first enable signal, Enable<1>, also causes the strobe signal 304 to be pulled HIGH since the Enable<1> signal is also input to the first driver 208 of the strobe/return signal driver circuit 119. The strobe signal 304 is propagated over the conductive line 120 to the receivers 118 and receipt of the rising edge of the strobe signal 304 indicates to the receivers 118 the presence of the first data, In<1>, on the bus 116 and causes the receivers to latch the data. In addition, the strobe signal 304 is propagated through the round-trip path 128 and is ultimately returned to the controller 114 as a return signal 305 shown superimposed on the strobe signal 304 in FIG. 3. This representation illustrates a resulting phase shift between the strobe signal 304 and the return signal 305, where the phase shift is (at least in one embodiment) a result of the propagation delay of the strobe signal through the round-trip path 128. Since the round-trip path 128 may be constructed to be at least as long as the conductive line 120, which provides the strobe signal 304 to the receivers 118, receipt of the return signal 305 by the controller 114 should occur (at least in one embodiment) no sooner than receipt of the strobe signal 304 by the receivers 118. Accordingly, the rising edge of the return signal 305 indicates to the controller 114 the assumed receipt of the first data by the receivers 118. Given this degree of assurance of the safe arrival of the first data, the second data can now be driven on the bus. Accordingly, the rising edge of the return signal 305 causes the controller 114 to de-assert the first enable signal 306, Enable<1>, and assert the second enable signal 308, Enable<2> (as indicated by the curvilinear arrows relating the rising edge of the return clock signal 305 to the falling edge of the first enable signal and the rising edge of the second enable signal 308). As a result, each of the second drivers 204 of the driver circuits 112 is enabled to drive second data, In<2>, onto their respective bus lines 116 (as indicated by the second solid straight arrow). The second enable signal 308, Enable<2>, may be de-asserted in response to the falling edge of the return signal 305 being received by the controller 114 (as indicated by the curvilinear arrow relating the falling edge of the return clock signal 306 to the falling edge of the second enable signal 308, Enable<2>).

From FIG. 3 it is clear that two data may be safely latched into the receivers 118 during a single clock period, tCLK. In one aspect, the same strobe clock signal (or at least a signal timed off of the strobe clock signal) that signals the receivers to latch in data from the bus, is returned to the controller 114 (in the form of the return signal 305) via the round-trip path 128 and causes the controller to drive the second data. With such a configuration, the rising edge of the return signal 305 is necessarily received by the controller before the strobe signal 304 is driven LOW. Accordingly, the second data will not inadvertently be driven to the bus prematurely (i.e., before confirmation of the assumed receipt of the first data by the receivers).

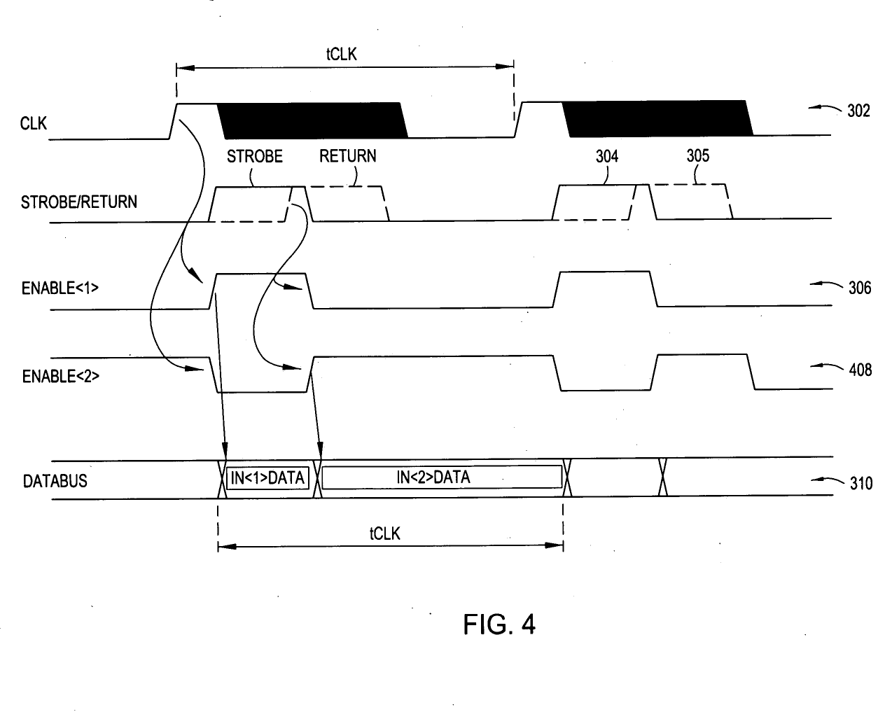

Referring now to FIG. 4, an alternative embodiment of a timing diagram is shown. With the exception of the Enable<2> signal 408, each of the signals shown in FIG. 4 behave in the same manner as described with respect to FIG. 3, and are, therefore, given the same reference numerals and will not be described again here. In this embodiment, once asserted, the Enable<2> signal 408 is kept HIGH for the duration of the clock period, tCLK. As a result, the second data is driven for the remaining duration of the clock period, tCLK, which may further assure the second data is latched properly at the receiver.

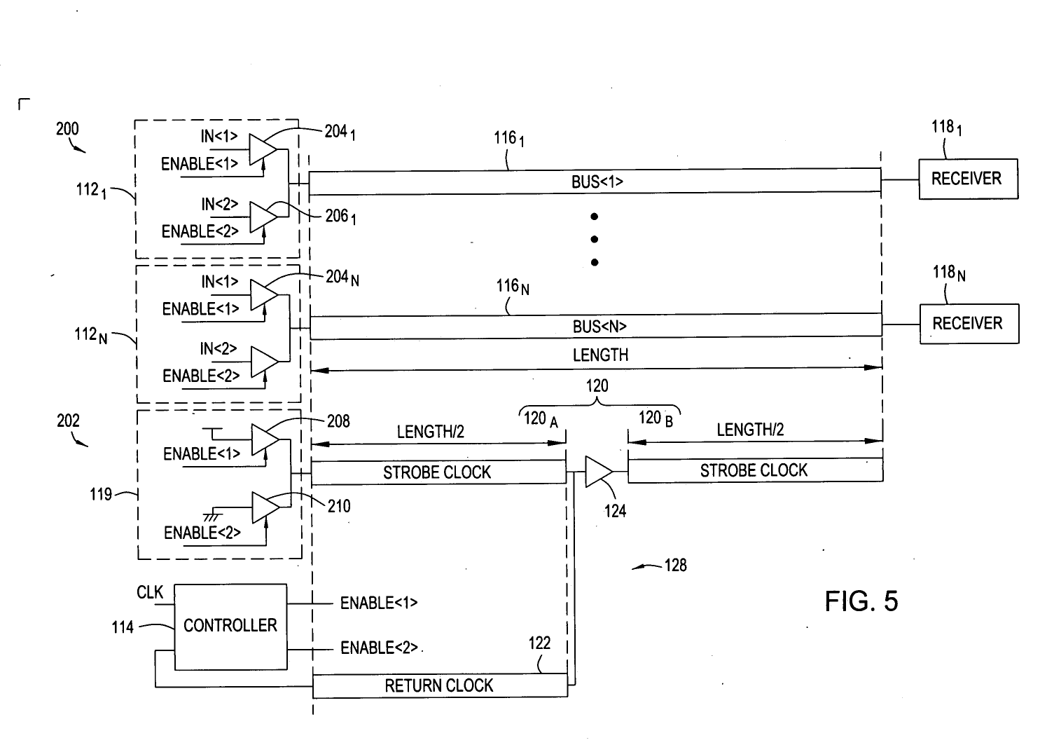

As noted above, it is contemplated that the round-trip path 128 may be constructed in a variety of different manners. For example, FIG. 5 shows an alternative embodiment in which the round-trip path 128 and the strobe clock line 120 have an approximate length equal to that of the bus lines 116. Thus, if the bus lines 116 have a length, L, then each segment (i.e., a strobe clock line segment 120A and the return clock line 122) of the round-trip path 128 has a length, L/2. The other segment 120B of the strobe clock line also has a length L/2. Accordingly, the return clock line 122 branches from the strobe clock line 120 at approximately a midpoint of the strobe clock line 120. The arrangement of FIG. 5 may be optimized for a maximum clock frequency in that the return clock signal arrives at the controller 114 substantially simultaneously with the strobe clock signal arriving at the receivers 118.

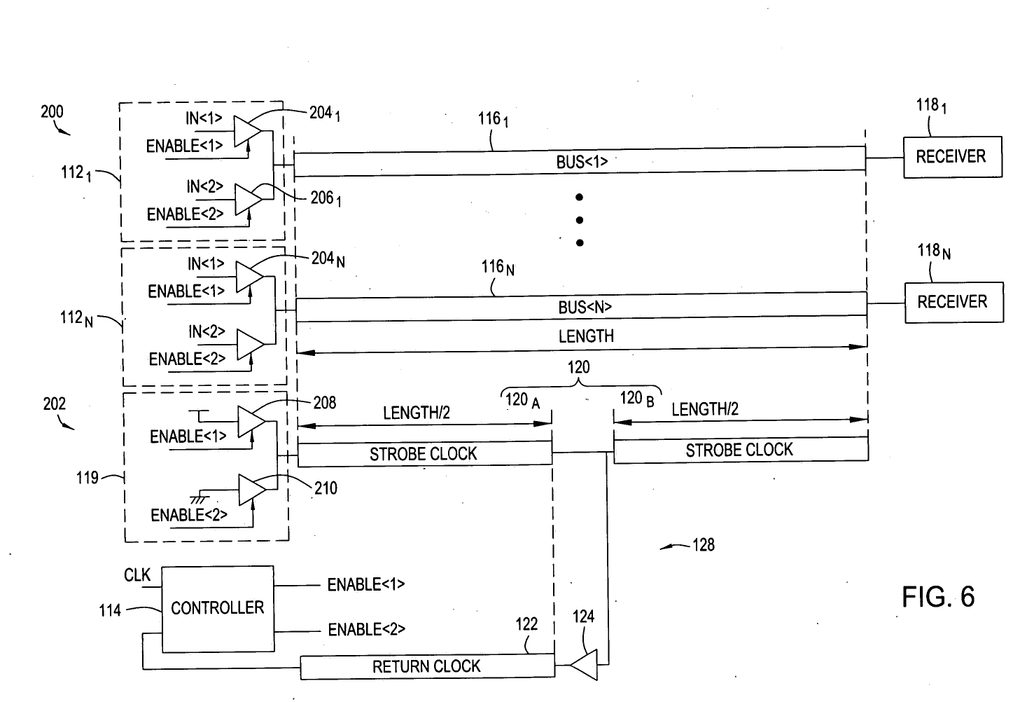

In one embodiment, the strobe clock signal continuing on to the receivers 118 may be buffered at a midpoint of the strobe clock line 120 (but beyond the turnaround point) by a buffer 124, as shown in FIG. 5. In another embodiment, the return clock signal may be buffered by the provision of a buffer 124 at an initial end of the return clock line 122 (or, more generally, anywhere along the return clock line 122), as shown in FIG. 6. In yet another embodiment, both the strobe clock signal end the return clock signal may be buffered.

The foregoing embodiments describe data being driven on bus lines in only one direction. Further, by way of illustration only, the embodiments described data being written to memory arrays 102 (see, FIG. 1). However, the return clock circuitry is equally applicable to clocking read data from the memory arrays 102. Thus, a return clock circuit may be implemented to clock data being driven over the data line 131 and latched into the read data latches 132. It is also contemplated that data may be driven bidirectionally over a given bus and clocked using a return clock scheme of the present invention.

One embodiment of data circuitry 700 having bidirectional bus lines 116 and associated control/clocking circuits 701L, 701R is shown in FIG. 7. For convenience only, relative orientation is described in FIG. 7 as left, right, left-hand or right-hand, and direction of signal propagation is described as left-to-right (l2r) or right-to-left (r2l). Further, to distinguish between corresponding left and right components, it was necessary to refer to some components by reference numerals not used in FIG. 1. However, it will be appreciated that similar terminology (e.g., drivers, driver circuits, receivers, etc.) is used to identify like components (with respect to those described above).

In contrast to previous embodiments described above, the data circuitry 700 shown in FIG. 7 includes driver circuits 702₁, 702₂, . . . 702_{N} (collectively representative of the “left-hand driver circuits 702”), 704₁, 704₂, . . . 704_{N} (collectively representative of the “right-hand driver circuits 704”) at each end of the bus lines 116. In addition, receivers 706₁, 706₂, . . . 706_{N} (collectively representative of the “left-hand receivers 706”), 708₁, 708₂, . . . 708_{N} (collectively representative of the “right-hand receivers 708”) are located at each end of the bus lines 116.

The driver circuits 702, 704 are each configured to drive multiple (at least two) data each clock cycle. Illustratively, the driver circuits 702, 704 are implemented for a double data rate memory device. Accordingly, the left-hand driver circuits 702 each have first data inputs, D_l2r<1> to respective first drivers 710₁, 710₂ . . . 710_{N} (collectively, first left-hand drivers 710) and second data inputs, D_l2r<2>, to respective second drivers 712₁, 712₂ . . . 712_{N} (collectively, second left-hand drivers 712); and the right-hand driver circuits 704 each have first data inputs, D_r2l<1> to respective first drivers 714₁, 714₂ . . . 714_{N} (collectively, first right-hand drivers 714) and second data inputs, D_r2l<2>, to respective second drivers 716₁, 716₂ . . . 716_{N} (collectively, second right-hand drivers 716).

Each control/clocking circuit 701L, 701R also has a respective strobe/return signal driver circuit 703L, 703R. The strobe/return signal driver circuits 703L and 703R each operate in a fashion similar to the strobe/return signal driver circuit 119 described above. Accordingly, the details of the strobe/return signal driver circuits 703L and 703R are not described again here.

The control/clocking circuits 701L, 701R each include round-trip paths 128L, 128R. The left-hand round-trip path 128L is defined by the left-hand strobe clock signal line 120L, a connecting line 720L and the left-hand return clock signal line 122L. The right-hand round-trip path 128R is defined by the right-hand strobe clock signal line 120R, a connecting line 720R and the right-hand return clock signal line 122R. Illustratively, the turnaround point for each of the round-trip paths 128L, 128R is approximately at a midpoint of the respective paths.

To ensure sufficient signal strength and avoid undesirable feedback, one or more buffers may be included in the control/clocking circuits 701L, 701R. Illustratively, two buffers 124₁, 124₂ are shown. The purpose of each buffer will be described below.

The drivers 710, 712, 714 and 716 are enabled to drive their respective data by a respective I/O controller 114L and 114R. Further, the strobe/return signal driver circuits 703L, 703R are configured to drive respective strobe signals between HIGH and LOW states according to input provided by their respective controller 114L, 114R. To this end, each controller 114L, 114R is configured to issue two enable signals, Enable_l2r<1>, Enable_l2r<2> and Enable_r2l<1>, Enable_r2l<2>, respectively.

In the left-to-right operation (i.e., driving data from the driver circuits 702 to the receivers 708), the data circuitry 700 and the control/clocking circuits 701L operate in substantially the same manner as the circuitry described with respect to FIG. 5. Therefore, a detailed description is not deemed necessary. One difference worth noting, however, is that the buffers 124₁, 124₂ are selectively and inversely enabled. Accordingly, during the left-to-right operation the first buffer 124₁ is enabled to allow propagation of the strobe signal to receivers 708 while the second buffer 124₂ is disabled to prevent feedback to the left-hand driver circuit 703_{L}.

During the right-to-left operation (i.e., driving data from the driver circuits 704 to the receivers 706), the first buffer 124₁ is disabled and the second buffer 124₂ is enabled. In this configuration, the strobe signal issued by the right hand strobe/return signal driver circuit 703R is propagated over the right-hand strobe clock signal line 120R and over the connecting line 720R to the second buffer 124₂. The buffered signal is then propagated to the left-hand side strobe clock signal line 120L, via the connecting line 720L, and then to the receivers 706. Accordingly, disabling the first buffer prevents undesirable feedback to the right-hand driver circuit 703_{R}. In both the left-to-right operation and the right-to-left operation the return clock signal is unaffected by the buffers 124₁, 124₂.

Generally, the timing operations of the circuit shown in FIG. 7 may be substantially the same as those described with respect to FIG. 2 (see timing diagrams of FIG. 3 and FIG. 4). However, the particular signal routing of FIG. 7 may result in some differences worth noting. In particular, the propagation time of the strobe signal during the right-to-left operation may be longer than the propagation time of the return signal. This is a result of causing the strobe signal to propagate from the right-hand strobe clock signal line 120R to the left-hand strobe clock signal line 120L via the connecting lines 720L, 720R and the second buffer 124₂. Accordingly, various steps may be taken to compensate for this delay, if necessary, in order to avoid driving the second data onto the bus lines 116 before the left-hand receivers 706 and latched in the first data. For example, the right-hand controller 114R may implement an additional delay upon receiving the rising edge of the strobe signal.

Referring now to FIG. 8, yet another embodiment of a return clock circuit shown. In general, like numbered elements as those shown in FIG. 7 operate in substantially the same manner as previously described. Accordingly, a detailed description of these elements is not necessary. In contrast to FIG. 7, however, the circuit of FIG. 8 prevents the strobe clock signals from each of the strobe/return signal driver circuits 703L, 703R from being passed to the opposing controller. This is made possible by allowing unbuffered propagation of the strobe signal along the strobe clock signal line 120 and providing buffers to restrict propagation of the strobe/return clock signal to the intended controller only. For example, during a left-to-right operation using the circuit of FIG. 7, the strobe signal issued by the left-hand driver circuit 703L may propagate to the intended left-hand controller 114L via the return clock signal line 122L, but also to the unintended right-hand controller 114R via the return clock line 122R. In contrast, during a left-to-right operation using the circuit of FIG. 8, the strobe signal issued by the left-hand driver circuit 703L may propagate only to the intended left-hand controller 114L via the return clock line 122L because the buffer 124₁ is enabled, and is prevented from propagating to the right-hand controller 122R because the buffer 124₂ is disabled. Conversely, during the right-to-left operation the first buffer 124₁ is disabled and the second buffer 124₂ is enabled.

The foregoing embodiments are merely illustrative. Persons skilled in the art will recognize other return clock implementations within the scope of the present invention.

While the foregoing is directed to embodiments of the present invention, other and further embodiments of the invention may be devised without departing from the basic scope thereof, and the scope thereof is determined by the claims that follow.

1. A method of operating a control circuit in a multiple data rate memory device, comprising, within a given clock period:
driving first data on a data bus;
transmitting, via a first signal path, a strobe signal to a receiving circuit indicating the validity of the first data on the data bus;
receiving a return signal indicating an assumed arrival of the strobe signal at the receiving circuit; and
in response to receiving the return signal, driving second data on the data bus.

2. The method of claim 1, wherein driving the first data and the second data on the data bus comprises enabling a driver to drive the data.

3. The method of claim 1, wherein the data bus is an internal data bus of the multiple data rate memory device.

4. The method of claim 1, wherein the multiple data rate memory device is a double data rate synchronous dynamic random access memory (DDR SDRAM).

5. The method of claim 1, wherein a duration of time between issuing the strobe signal and receiving the return signal is at least as long as a duration of time required for the strobe signal to propagate from the control circuit to the receiving circuit.

6. The method of claim 1, wherein a duration of time between issuing the strobe signal and receiving the return signal is substantially equal to a duration of time required for the strobe signal to propagate from the control circuit to the receiving circuit.

7. The method of claim 1, wherein the return signal is the strobe signal.

8. The method of claim 1, further comprising generating the return signal by the receiving circuit.

9. The method of claim 8, wherein generating the return signal comprises buffering the strobe signal.

10. A method of operating a multiple date rate memory device, comprising, within a given clock period:
(a) driving a first data on a data bus;
(b) issuing a strobe signal from a controller;
(c) receiving, by a receiving circuit, the strobe signal a period of time after issuing the strobe signal;
(d) in response to receiving the strobe signal by the receiving circuit, latching in the first data from the data bus;
(e) receiving, by the controller, the strobe signal a period of time after issuing the strobe signal; and
(f) in response to receiving the strobe signal by the controller, driving a second data on a data bus.

11. The method of claim 10, wherein (a)-(f) are performed bidirectionally over the data bus.

12. The method of claim 10, wherein the strobe signal is propagated to the receiving circuit on a first path and propagated to the controller on a second path, and wherein only a portion of each path shares a common line.

13. The method of claim 10, wherein the strobe signal is propagated to the receiving circuit on a first path and propagated to the controller on a second path, and wherein lengths of the first and second paths are substantially the same.

14. The method of claim 10, further comprising:
(g) latching the second data in from the data bus.

15. The method of claim 10, wherein the multiple data rate memory device is a double data rate synchronous dynamic random access memory (DDR SDRAM).

16. A method of operating a multiple date rate memory device, comprising, within a given clock period:
(1) by a driver controller:
driving first data on a data bus;
transmitting a data strobe signal to a receiver via a forward signal path;
receiving the data strobe signal via a return signal path; and
in response to receiving the strobe signal, driving second data on the data bus; and
(2) by a receiver:
receiving the strobe signal via the forward signal path; and
in response to receiving the strobe signal, latching the first data in from the data bus.

17. The method of claim 16, wherein the forward signal path is defined on a first line and the return signal path is defined on a second line branching from the first line.

18. A method of operating a control circuit in a multiple date rate memory device, comprising, within a given clock period:
enabling a driver to drive a first data on a data bus;
issuing a strobe signal to a receiving circuit via a forward signal path to indicate the presence of the first data on the data bus;
receiving the strobe signal via a return signal path, wherein receipt of the strobe signal indicates an assumed arrival of the strobe signal at the receiving circuit via the forward signal path; and
in response to receiving the strobe signal, enabling a driver to drive a second data on the data bus.

19. The method of claim 18, wherein a period of time between issuing the strobe signal and receiving the strobe signal is at least as long as a duration of time required for the strobe signal to propagate from the control circuit to the receiving circuit.

20. The method of claim 18, wherein a period of time between issuing the strobe signal and receiving the strobe signal is substantially equal to a duration of time required for the strobe signal to propagate from the control circuit to the receiving circuit.

21. The method of claim 18, wherein receiving the strobe signal by the control circuit occurs substantially simultaneously with receipt of the strobe signal by the receiving circuit.

22. The method of claim 18, wherein the data bus is an internal data bus of the multiple data rate memory device.

23. The method of claim 18, further comprising, within the given clock period, driving the first data on the data bus.

24. The method of claim 18, wherein the multiple data rate memory device is a double data rate synchronous dynamic random access memory.

25. The method of claim 18, wherein the strobe signal is issued on a first line and is received on a second line, wherein the first line and the second line form at least part of a round-trip path for propagating the strobe signal.

26. The method of claim 25, wherein the first line is coupled to the receiving circuit.

27. A multiple data rate memory device, comprising:
a controller configured to generate one or more driver-enable signals and a strobing clock signal;
a data bus;
a driver circuit configured to drive a first data and a second data on the data bus in response to the one or more driver-enable signals from the controller;
a receiver circuit configured to receive the first and second data via the data bus, the receiver circuit configured to latch the first and second data in response to the strobing clock signal generated by the controller;
a strobe clock signal line to propagate the strobing clock signal from the controller to the receiver circuit; and
a round-trip path comprising a return path for the strobing clock signal back to the controller;
wherein the controller is configured to enable the driver circuit to drive the first data on the data bus, generate the strobing clock signal propagated to the receiver circuit on the strobe clock signal line, receive the strobing clock signal on the round-trip path and, in response to receiving the strobe clock signal, enable the driver circuit to drive the second data on the data bus.

28. The multiple data rate memory device of claim 27, wherein the round-trip path is partially defined by the strobe clock signal line.

29. A multiple data rate memory device, comprising:
a driver configured to drive at least a first data and a second data;
a receiver coupled to the driver;
a controller coupled to the driver and configured to enable the driver to drive the first data and the second data;
a strobe clock signal line coupled between the receiver and controller and configured to propagate a strobe clock signal; and
a return clock signal line coupled at an output end to the controller and configured to propagate a return clock signal signaling the controller to enable the driver to drive the second; wherein the return clock signal is timed off of the strobe clock signal.

30. The device of claim 29, wherein the strobe clock signal and the return clock signal have a period no longer than a period of an external clock signal received by the controller.

31. The device of claim 29, wherein the multiple data rate memory device is a double data rate synchronous dynamic random access memory.

32. A clocking circuit in a multiple data rate memory device, comprising:
a controller comprising a strobe clock signal output and a return clock signal input and configured to issue a first enable signal and a second enable signal, the first enable signal enabling a plurality of drivers to drive respective first data on respective data lines, and the second enable signal enabling the plurality of drivers to drive respective second data on their respective data lines;
a strobe clock signal line coupled to the strobe clock signal output; and
a return clock signal line coupled to the return clock signal input; wherein the strobe clock signal line defines an initial portion of a round-trip path and the return clock signal line defines a terminal portion of the round-trip path; and wherein the controller is configured to:
respond to an external clock signal by pulling a strobe clock signal to a first state on the strobe clock signal line and pulling the first enable signal to an active state;
receive a return clock signal on the return clock signal line a period of time after pulling the strobe clock signal to the first state, wherein the return clock signal is timed off of the strobe clock signal and indicates an assumed receipt of the strobe clock signal in the active state by receiving circuitry coupled to the respective data lines and configured to latch in the first and second data from the data lines in response to the strobe clock signal; and
respond to the received return clock signal by pulling the second enable signal to an active state.

33. The clocking circuit of claim 32, wherein the multiple data rate memory device is a double data rate synchronous dynamic random access memory.

34. The clocking circuit of claim 32, wherein the strobe clock signal line is coupled to the return clock signal line and to the receiving circuitry.

35. The clocking circuit of claim 32, wherein the receiving circuitry is configured to latch in the first data from the data lines in response to receiving the strobe clock signal in the first state and to latch in the second data from the data lines in response to receiving a transition of the strobe clock signal from the first state to a second state.

36. The clocking circuit of claim 32, wherein the return clock signal is a delayed instance of the strobe clock signal.

37. The clocking circuit of claim 32, wherein the strobe clock signal and the return clock signal are issued within a single period of an external clock signal.

38. The clocking circuit of claim 37, wherein the return clock signal is a delayed instance of the strobe clock signal.

39. A multiple data rate memory device, comprising:
a bidirectional data bus;
a first driver circuit coupled to the bus and configured to propagate a first data and a second data in a first direction along the bus;
a first receiver circuit coupled to an end of the bus opposite the first driver circuit and configured to latch the first and second data in response to a first strobe clock signal;
a second driver circuit coupled to the bus and configured to propagate a third data and a fourth data in a second direction along the bus;
a second receiver circuit coupled to an end of the bus opposite the second driver circuit and configured to latch the third and fourth data in response to a second strobe clock signal;
a first controller configured to enable the first driver circuit and to generate the first strobe clock signal;
a second controller configured to enable the second driver circuit and to generate the second strobe clock signal;
a first strobe clock signal line to propagate the first strobe clock signal from the first controller to the first receiver circuit;
a first round-trip path comprising a first return path for the first strobe clock signal back to the first controller;
a second strobe clock signal line to propagate the second strobe clock signal from the second controller to the second receiver circuit; and
a second round-trip path comprising a second return path for the second strobe clock signal back to the second controller.

40. The multiple data rate memory device of claim 39, wherein the first round-trip path is partially defined by the first strobe clock signal line and the second round-trip path is partially defined by the second strobe clock signal line.

41. The multiple data rate memory device of claim 39, wherein:
the first controller is configured to enable the first driver circuit to drive the first data on the data bus, generate the first strobe clock signal propagated to the first receiver circuit on the first strobe clock signal line, receive the first strobe clock signal on the first round-trip path and, in response to receiving the first strobe clock signal, enable the first driver circuit to drive the second data on the data bus; and
the second controller is configured to enable the second driver circuit to drive the third data on the data bus, generate the second strobe clock signal propagated to the second receiver circuit on the second strobe clock signal line, receive the second strobe clock signal on the second round-trip path and, in response to receiving the second strobe clock signal, enable the second driver circuit to drive the fourth data on the data bus.

42. The multiple data rate memory device of claim 39, wherein the first strobe clock signal line comprises at least a portion of the second strobe clock signal line.
